(19) United States
(12) Patent Application Publication
(10) Pub. No.: US 2016/0201296 A1
(43) Pub. Date: Jul. 14, 2016

(54) HYDRAULIC VALVE

(71) Applicant: Caterpillar Inc., Peoria, IL (US)

(72) Inventor: John Ferraz, JR., Romeoville, IL (US)

(73) Assignee: Caterpillar Inc., Peoria, IL (US)

(21) Appl. No.: 15/079,176

(22) Filed: Mar. 24, 2016

(51) Int. Cl. E02F 9/22; F16K 1/32

(52) U.S. Cl. CPC E02F 9/2225; F16K 1/32

(57) ABSTRACT

A hydraulic valve for a machine is provided. The hydraulic valve includes a valve housing having a passage defined therein. The valve housing defines a first chamber maintained at a first predetermined pressure. The first chamber includes a retaining member, a first and a second support member coupled to the retaining member, and a resilient member disposed on the retaining member. The valve housing further defines a second chamber maintained at a second predetermined pressure. Further, an intermediate chamber is defined between the first chamber and the second chamber, and a valve member is slidably disposed in the intermediate chamber. The valve member blocks the passage in a closed position and unblocks passage in an open position. The resilient member is compressed in the first chamber and the valve moves from first position to second position when value of second predetermined pressure is less than the first predetermined pressure.

### TECHNICAL FIELD

The present disclosure relates to a hydraulic system and more particularly relates to a hydraulic valve of the hydraulic system.

### BACKGROUND

A hydraulic system of a machine, such as an excavator and a backhoe loader, typically includes pumps, hydraulic valves, and actuators. The hydraulic valve assists in multiple operations of the hydraulic system. For instance, the hydraulic valve prevents the hydraulic system from being subjected to overload conditions by maintaining a predetermined pressure difference between various branches of the hydraulic system and controlling direction of flow of fluid. Typically, the hydraulic valve includes an inlet, an outlet, and a passage formed between the inlet and the outlet. Further, a pilot operated support member is disposed in the hydraulic valve which is actuated by an actuator. Upon actuation, the support member slides within the hydraulic valve to block and unblock the passage, thereby restricting and allowing the flow of fluid between the inlet and the outlet, respectively. However, during operation of the hydraulic valve, leakage of fluid often takes place. Any leakage of fluid during the operation of the hydraulic valve is undesirable as it may adversely effect proper functioning of the hydraulic system.

US Publication Number 2014/0026985 ('985 patent publication) describes a hydraulic flow control valve that includes a fluid flow control poppet valve, a pilot operator, a solenoid operator, and a pressure compensator. The poppet valve includes a poppet and a seat. The pilot operator includes a pilot and a pilot seat. The solenoid operator includes a solenoid tube and an armature. The pressure compensator includes a pressure balanced pressure compensator spool, a smaller diameter differential pressure compensator control piston, and springs that balance the forces on the compensator control piston. The compensator control piston moves the compensator spool to maintain a substantially constant pressure differential across the poppet valve. However, the hydraulic flow control valve of the '985 patent publication is prone to leakage which may prevent the hydraulic flow control valve from maintaining a constant pressure differential across the poppet valve.

### SUMMARY OF THE DISCLOSURE

According to an aspect of the present disclosure, a hydraulic valve for a machine is provided. The hydraulic valve includes a valve housing having a first end and a second end distal with respect to the first end. The valve housing includes an inlet and an outlet in fluid communication with the inlet via a passage. The valve housing further includes a first chamber defined at the first end of the valve housing, the first chamber being maintained at a first predetermined pressure. The first chamber includes a retaining member adapted to move between a first position and a second position based on change in the first predetermined pressure. The first chamber further includes a first support member and a second support member. The first support member and the second support member are coupled to the retaining member, the second support member being distal from the first support member on the retaining member. Furthermore, the first chamber includes a resilient member coaxially disposed on the retaining member and between the first support member and the second support member. The resilient member is adapted to restrict movement of the retaining member from the first position to the second position. The valve housing further includes a second chamber defined at the second end of the valve housing, the second chamber being maintained at a second predetermined pressure. An actuator is operably coupled to the second chamber to selectively vent pressure from the second chamber for decreasing a value of the second predetermined pressure with respect to a value of the first predetermined pressure. The valve housing further includes an intermediate chamber defined between the first chamber and the second chamber. The intermediate chamber defines a seating between the first chamber and the intermediate chamber to accommodate the second support member. The second support member is adapted to seal the first chamber from the intermediate chamber. The valve housing further includes a valve member slidably disposed in the intermediate chamber and coupled to the retaining member. The valve member is adapted to move between an open position and a closed position. The valve member blocks the passage in the closed position to restrict flow of fluid from the inlet to the outlet and unblocks the passage in the open position to allow flow of fluid from the inlet to the outlet. The resilient member is compressed in the first chamber and the valve member moves from the open position to the closed position for restricting flow of fluid from the inlet to the outlet, when the value of the second predetermined pressure is less than the value of the first predetermined pressure.

Other features and aspects of this disclosure will be apparent from the following description and the accompanying drawings.

### BRIEF DESCRIPTION OF THE DRAWINGS

FIG. 1 is a block diagram of a hydraulic system having a hydraulic valve, according to one embodiment of the present disclosure;

FIG. 2 is a cross sectional view of the hydraulic valve in an open position; and

FIG. 3 is a cross sectional view of the hydraulic valve in a closed position.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

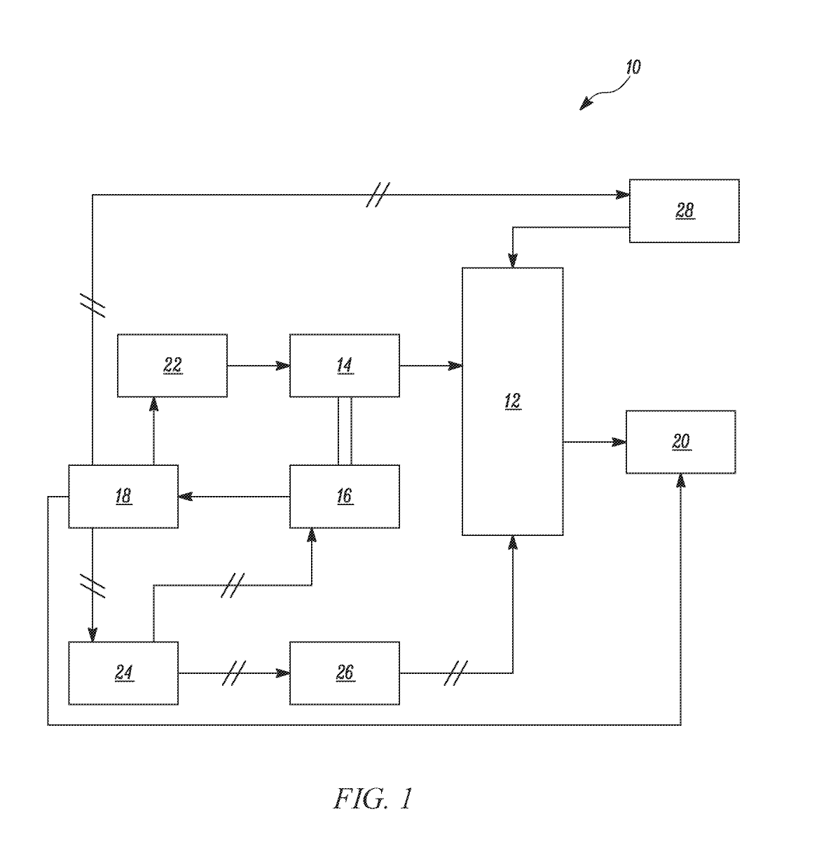

FIG. 1 is a block diagram of a hydraulic system 10 of a machine, having a hydraulic valve 12, hereinafter referred to as the valve 12. The hydraulic system 10 includes a motor 14 and a main pump 16 coupled to the motor 14 by a drive shaft 15. Owing to such coupling, the motor 14 assists the main pump 16 to draw fluid form a tank (not shown) and deliver the fluid to an implement valve 18. Further, torque generated by the motor 14 aids in maintaining a constant hydraulic pressure for the fluid passing through main pump 16. The implement valve 18 is connected between the main pump 16 and an accumulator 22. The implement valve 18 controls flow and direction of the fluid from the main pump 16 to one of a reservoir 20 and the accumulator 22. The implement valve 18 may be one of but is not limited to, a direction control valve, a flow control valve, a pressure control valve, and an electro-hydraulic valve. In an example, the implement valve 18 may be coupled to an implement of the machine. The accumulator 22 may be understood as a storage device for storing the fluid under pressure.

The hydraulic system 10 further includes a controller 24. In one example, the controller 24 may be a processor that includes a single processing unit or a number of processing units, all of which include multiple computing units. The explicit use of the term ‘processor’ should not be construed to refer exclusively to hardware capable of executing a software application. Rather, in this example, the controller 24 may be implemented as one or more microprocessors, microcomputers, digital signal processor, central processing units, state machine, logic circuitries, and/or any device that is capable of manipulating signals based on operational instructions. Among the capabilities mentioned herein, the controller 24 may also be configured to receive, transmit, and execute computer-readable instructions. The implement valve 18 is also coupled to the controller 24 on one hand and to a pilot pump 28 on the other.

The controller 24 is further coupled to the valve 12 through the actuator 26. In an example, the actuator 26 may be a solenoid-actuated device provided with a solenoid-coil arrangement. The solenoid-coil when energized causes the solenoid to move to-and-fro. In another example, the actuator 26 may also be a single piston-cylinder arrangement or a dual piston-cylinder arrangement.

In operation, the motor 14 operates the main pump 16 to supply fluid from the reservoir 20 to the implement valve 18. An operator of the machine controls the movement of the implement to a desired position by aid of one or more levers in the machine. As such, on actuation of the one or more levers, the implement can be moved and positioned at a desired position and elevation. The movement of the implement is controlled by controlling amount of fluid flowing through the implement valve 18 of the implement. The implement valve 18 also delivers the fluid to the accumulator 22 and any extra fluid, or overflowing fluid, is directed to the reservoir 20. Accordingly, in order to allow movement of the implement from a first position to a second position, the fluid is allowed to flow from the main pump 16 to the reservoir 20 through the accumulator 22, the motor 14, and the valve 12. The first position and the second position of the implement may be understood as the positions during operation of the implement, for example during loading and unloading of materials.

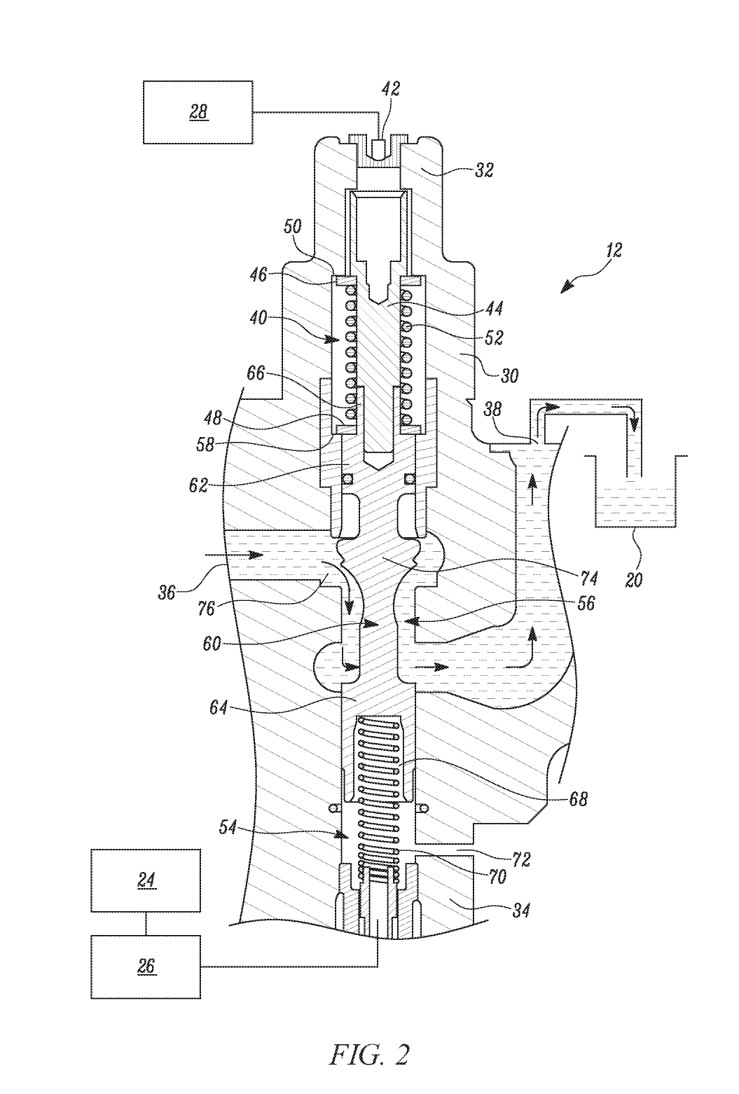

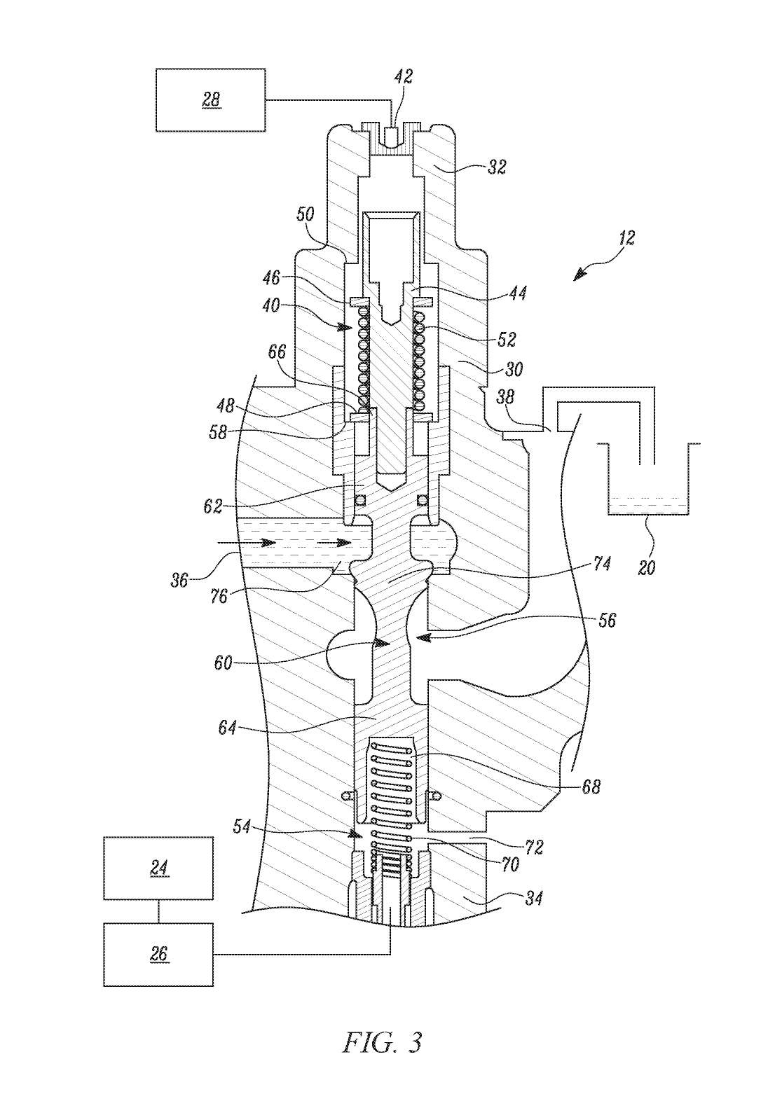

When the operator wishes to retain the implement at a desired position, the operator operates the one or more levers for controlling flow of fluid through a flow path describes above. On such actuation, the controller 24 receives input from the one or more levers. Based on the input from the one or more levers, the controller 24 operates the main pump 16, the implement valve 18, and the actuator 26. For instance, the controller 24 controls the operation of the main pump 16 and gradually decreases the flow of fluid from the main pump 16 to the implement valve 18. On sensing such decrease in flow of fluid, the implement valve 18 transmits a signal to the pilot pump 28 for operating the valve 12. On the other hand, the controller 24 simultaneously actuates the actuator 26 of operating the valve 12. Operation of the valve 12 from both the pilot pump 28 and the actuator 26 aids in restricting the flow of fluid to the reservoir 20. Such restriction of fluid assists in retaining the implement at the desired position. The manner in which the pilot pump 28 and the actuator 26 control the operation of the valve 12 would be described with respect to FIG. 2 and FIG. 3. In cases where the implement of the machine is required to be further displaced, the operator may operate the one or more valve which would allow flow of fluid through the valve 12 and into the reservoir 20.

FIG. 2 shows a cross-sectional view of the hydraulic valve hereinafter referred to as the valve 12. The valve 12 is adapted to control flow of fluid from the motor 14 to the reservoir 20. In an example, the valve 12 may be a one direction control valve, a flow control valve, a pressure control valve, or an electro-hydraulic valve. The valve 12 includes a valve housing 30 having a first end 32 and a second end 34. In addition, an inlet 36 and an outlet 38 are formed in the valve housing 30. The inlet 36 and the outlet 38 may be understood as openings or ports provided in the valve housing 30 for allowing entry and exit of fluid to and from the valve 12, respectively. For instance, the inlet 36 allows fluid communication between the valve 12 and the motor 14, and the outlet 38 allows fluid communication between the valve 12 and the reservoir 20.

Further, the valve 12 includes a first chamber 40 defined at the first end 32 of the valve housing 30. The first chamber 40 may be understood as a hollow space formed at the first end 32 of the valve housing 30 to accommodate one or more components for the operation of the valve 12. The first chamber 40 is maintained at a first predetermined pressure ‘P1’. The pilot pump 28 aids in maintaining the first chamber 40 at the first predetermined pressure ‘P1’ during the operation of the hydraulic system 10. As such, the pilot pump 28 is operably coupled to the first chamber 40. In an example, a conduit or a port 42 may be provided in the first chamber 40 for coupling the pilot pump 28 to the first chamber 40.

As mentioned earlier, the first chamber 40 is adapted to accommodate one or more components. Accordingly, the first chamber 40 includes a retaining member 44 adapted to move between a first position ‘S1’ and a second position ‘S2’. The retaining member 44 is embodied as a stepped piston member, where cross-sectional area of the retaining member 44 decreases in stages from one end to the other along the length of the retaining member 44, as shown in FIG. 2. The retaining member 44 is disposed in the first chamber 40 and lies in the first position ‘S1’ during normal operating conditions of the valve 12. The first chamber 40 further includes a first support member 46 and a second support member 48. Each of the first support member 46 and the second support member 48 is coupled to the retaining member 44 and along the length of the retaining member 44 in a manner, such that the second support member 48 is distal from the first support member 46. In an example, the first support member 46 and the second support member 48 may be individual components disposed in the first chamber 40, such that each of the first support member 46 and the second support member 48 are coaxial with respect to the retaining member 44.

Additionally, the first chamber 40 is formed in a manner to define a sleeve portion 50 to accommodate the first support member 46. For instance, a cross-sectional area of the sleeve portion 50 may be less than a cross-sectional area of the first support member 46, so that the first support member 46 seats in the sleeve portion 50. Further, in order to retain the second support member 48 distant from the first support member 46, the first chamber 40 further includes a resilient member 52. The resilient member 52 is coaxially disposed on the retaining member 44 and between the first support member 46 and the second support member 48, as shown in FIG. 2. Although the FIG. 2 shows a single resilient member 52 coaxially disposed on the retaining member 44, it will be appreciated that two or more resilient members may be employed in the first chamber 40 between the first support member 46 and the second support member 48. In an example, two resilient members may be disposed in a diametrically opposite configuration and between the first support member 46 and the second support member 48. In such an arrangement, the retaining member 44 secures the first support member 46, the second support member 48, and the resilient member 52 in position. Furthermore, the resilient member 52 is adapted to restrict movement of the retaining member 44 from the first position ‘S1’ to the second position ‘S2’. With reference to the arrangement of components described herein, the first position ‘S1’ and the second position ‘S2’ may be understood as positions during movement of the retaining member 44 along a vertical axis of the valve 12. Further, such movement of the retaining member 44 is based on a change in the first predetermined pressure of the first chamber 40. The manner in which the change in the first predetermined pressure ‘P1’ causes the movement of the retaining member 44 would be described later.

The valve 12 further includes a second chamber 54 defined at the second end 34 of the valve housing 30. The second chamber 54 is being maintained at a second predetermined pressure ‘P2’. In an example, the valve 12 may employ at a pressure device to maintain the second chamber 54 at the second predetermined pressure ‘P2’. In another example, fluid housed in the second chamber 54 may allow maintaining the second chamber 54 at the second predetermined pressure ‘P2’.

Further, the actuator 26 is operably coupled to the second chamber 54 to selectively vent pressure from the second chamber 54. Such venting of pressure causes a decrease in value of the second predetermined pressure ‘P2’ with respect to the first predetermined pressure ‘P1’. The valve housing 30 further includes an intermediate chamber 56 defined between the first chamber 40 and the second chamber 54. The intermediate chamber 56 defines a seating 58 between the first chamber 40 and the intermediate chamber 56 to accommodate the second support member 48. For example, a cross-sectional area of the intermediate chamber 56 may be less than the cross-sectional area of the first chamber 40. Owing to such difference in cross-sectional area, the seating 58 is formed at a junction where the first chamber 40 connects the intermediate chamber 56, as shown in FIG. 2. As such, the seating 58 may be understood as a region formed by narrowing the cross-section of the valve housing 30. Further, the seating 58 may be adapted to accommodate the second support member 48, so that the second support member 48 functions as a stopper to one end of the resilient member 52.

The valve 12 further includes a valve member 60 slidably disposed in the intermediate chamber 56. The valve member 60 has a first end 62 and a second end 64. An annular projection 66 extends from the first end 62 of the valve member 60 to receive one end of the retaining member 44 therein. In an assembled condition, the second support member 48 surrounds the annular projection 66 of the valve member 60, thereby sealing the first chamber 40 from the intermediate chamber 56. However, in an example, the valve member 60 may not include the annular projection 66 and, in such cases, the second support member 48 can be adapted to seal the first chamber 40 from the intermediate chamber 56 by forming a close fit with respective surfaces of the retaining member 44, the valve housing 30, and the valve member 60.

Further, the second end 64 of the valve member 60 also includes a hollow annular slot 68 to receive an elastic member 70 therein, as shown in FIG. 2. The elastic member 70 may be disposed in the second chamber 54. While one end of the elastic member 70 lies within the hollow annular slot 68, the other end of the elastic member 70 may be coupled to the actuator 26. In an example, the actuator 26 may include a piston-cylinder arrangement or a solenoid. On receipt of the inputs from the controller 24, the actuator 26 vents pressure from the second chamber 54. For example, on receipt of the inputs from the controller 24, the piston (not shown) of the actuator 26 may move in a direction towards the second chamber 54, thereby decreasing volume of the second chamber 54 and venting the pressure from the second chamber 54. For the purpose of venting the pressure, the second chamber 54 may include a vent port 72. As such, during the movement of the piston of the actuator 26 towards the second chamber 54, the elastic member 70 compresses. However, in case of the solenoid-coil arrangement in the actuator 26, a coil surrounding the solenoid may be energized based on actuation of the actuator 26.

Further, a peripheral surface ‘P’ at a stem portion 74 the valve member 60 forms a passage 76 with inner surface ‘S’ of the valve housing 30, as shown in FIG. 2. The passage 76 allows flow of fluid from the inlet 36 to the outlet 38 and to the reservoir 20 thereafter. Such a position of the valve member 60 in the valve 12, defining the passage 76, may be understood as an open position ‘O’ of the valve member 60. As such, the valve member 60 unblocks the passage 76 in the open position ‘O’, thereby allowing flow of fluid from the inlet 36 to the outlet 38. The valve member 60 is adapted to move between the open position ‘O’ and a closed position ‘C’ which will be described below with respect to FIG. 3.

In operation, when the implement of the machine needs to be moved to second position from the first position, the valve member 60 is retained in the open position ‘O’. The fluid flows from the inlet 36 to the outlet 38 in the open position ‘O’ of the valve member 60, thereby allowing movement of the implement to the desired position. Once an operator of the machine has determined that the implement has reached the desired position, the operator may operate a lever to restrict the movement of the implement. In such cases, flow of fluid to the implement valve 18 may need to be restricted, so that further flow of fluid does not lead to further movement of the implement.

Accordingly, upon actuation of the lever, the controller 24 is configured to receive the signal from the lever. Subsequently, the controller 24 actuates the actuator 26 and the pilot pump 28. As described earlier, the pilot pump 28 maintains the first chamber 40 at the first predetermined pressure ‘P1’ and the actuator 26 is adapted to selectively vent pressure from the second chamber 54. Due to the venting of the pressure from the second chamber 54, a value of the second predetermined pressure ‘P2’ of the second chamber 54 decreases. Simultaneously, the pilot pump 28 pumps in additional pressure, for example in form of additional fluid, into the first chamber 40. Therefore, a value of the pressure in the first chamber 40 gradually increases while the value of pressure in the second chamber 54 gradually decreases. As a result, the value of the first predetermined pressure ‘P1’ increases over a value of the second predetermined pressure ‘P2’. It will appreciated by a person skilled in the art that the additional pressure required to be developed in the first chamber 40, or the additional fluid to be supplied by the pilot pump 28 into the first chamber 40, may be configured based on resilience force of the resilient member 52. Therefore, based on the pressure required to be maintained in the first chamber 40 and based on the actuation of the implement of the machine, the resilient member 52 may be accordingly selected.

Further, owing to such increase in value of the first predetermined pressure ‘P1’ in the first chamber 40, a thrust corresponding to the pressure in the first chamber 40 is applied on the retaining member 44, thereby causing the retaining member 44 to move from the first position ‘S1’ to the second position ‘S2’. In other words, the valve member 60 moves from the first position ‘S1’ to the second position ‘S2’ when the value of the second predetermined pressure ‘P2’ is less than the value of the first predetermined pressure ‘P1’. Since the first support member 46 is coupled to the retaining member 44, movement of the retaining member 44 from the first position ‘S1’ to the second position ‘P2’ also causes the first support member 46 to move along with the retaining member 44. Accordingly, the resilient member 52 disposed between the first support member 46 and the second support member 48 compresses. It will be understood that the compression of the resilient member 52 takes place against the second support member 48 that is seated on the seating 58 formed between the first chamber 40 and the intermediate chamber 56.

Furthermore, since the retaining member 44 is coupled to the valve member 60, the retaining member 44 causes the valve member 60 to move in the direction of the movement of the retaining member 44. In additional to the actuator 26, the movement of the valve member 60 towards the second chamber 54 also aids in venting the pressure from the second chamber 54, against a resilience force of the elastic member 70. Such movement of the valve member 60 causes the stem portion 74 of the valve member 60 to contact the inner surface ‘S’ of the valve housing, thereby blocking the passage 76. This position of the valve member 60 may be understood as the closed position ‘C’. Therefore, the valve member 60 blocks the passage 76 in the closed condition ‘C’ to restrict flow of fluid from the inlet 36 to the outlet 38. When the operator desires to move the implement further, the lever may be further operated. In turn, the controller 24 receives a corresponding input from the lever and actuates the actuator 26. On such actuation, the actuator 26 increases the pressure in the second chamber 54.

Owing to such increase in pressure in the second chamber 54, the valve member 60 is forced in a direction towards the first chamber 40. Accordingly, the valve member 60 moves from the closed position ‘C’ to the open position ‘O’, thereby allowing flow of fluid from the inlet 36 to the outlet 38 and thereafter to the implement valve 18.

Various embodiments disclosed herein are to be taken in the illustrative and explanatory sense, and should in no way be construed as limiting of the present disclosure.

### INDUSTRIAL APPLICABILITY

The present disclosure provides the valve 12 for the machine. The resilient member 52, the first support member 46, and the second support member 48 assists in movement of the valve member 60 from the open position ‘O’ to the closed position ‘C’, based on inputs from the controller 24, in addition, the second support member 48 aids in sealing the first chamber 40 from the intermediate chamber 56. Accordingly, pressure developed in the first chamber 40 may be maintained at required value, which was otherwise used to vary in conventional valves due to leakage of pressure. Furthermore, since the actuator 26 is coupled to the second chamber 54, pressure is vented from the second chamber 54 to assist in operation of the valve 12.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A hydraulic valve for a machine, the hydraulic valve comprising:
a valve housing having a first end and a second end distal with respect to the first end, the valve housing comprising:
an inlet;
an outlet in fluid communication with the inlet via a passage;
a first chamber defined at the first end of the valve housing, the first chamber being maintained at a first predetermined pressure, the first chamber comprising:
a retaining member adapted to move between a first position and a second position based on change in the first predetermined pressure;
a first support member coupled to the retaining member;
a second support member coupled to the retaining member and distal from the first support member; and
a resilient member coaxially disposed on the retaining member and between the first support member and the second support member, the resilient member adapted to restrict movement of the retaining member from the first position to the second position;
a second chamber defined at the second end of the valve housing, the second chamber being maintained at a second predetermined pressure, wherein an actuator is operably coupled to the second chamber to selectively vent pressure from the second chamber for decreasing a value of the second predetermined pressure with respect to a value of the first predetermined pressure;
an intermediate chamber defined between the first chamber and the second chamber, wherein the intermediate chamber defines a seating between the first chamber and the intermediate chamber to accommodate the second support member, wherein the second support member is adapted to seal the first chamber from the intermediate chamber; and
a valve member slidably disposed in the intermediate chamber and coupled to the retaining member, the valve member adapted to move between an open position and a closed position,
wherein the valve member blocks the passage in the closed position to restrict flow of fluid from the inlet to the outlet and unblocks the passage in the open position to allow flow of fluid from the inlet to the outlet, and
wherein the resilient member is compressed in the first chamber and the valve member moves from the open position to the closed position for restricting flow of fluid from the inlet to the outlet, when the value of the second predetermined pressure is less than the value of the first predetermined pressure.
